(19) United States
(12) Patent Application Publication
(10) Pub. No.: US 2014/0271361 A1
(43) Pub. Date: Sep. 18, 2014

(54) CONTOURED DISPENSER

(71) Applicant: Biomedical Polymers, Inc., Gardner, MA (US)

(72) Inventors: Michael T. Faulkner, Leominster, MA (US); Wayne M. Miller, West Townsend, MA (US)

(73) Assignee: Biomedical Polymers, Inc., Gardner, MA (US)

(21) Appl. No.: 14/288,590

(22) Filed: May 28, 2014

Related U.S. Application Data
(63) Continuation-in-part of application No. 13/385,680, filed on Mar. 1, 2012.

(51) Int. Cl. G01N 1/28

(52) U.S. Cl. CPC G01N 1/28; G01N 2001/002
USPC 422/68.1; 422/521

(57) ABSTRACT

A blood testing system includes a cartridge loadable into a blood analyzer. One cartridge includes a convex top portion with a blood entry port therein. A dispenser transfers blood in a stoppered test tube to the cartridge. One dispenser includes a contoured, stabilizing base configured to mate with the cartridge convex top portion. The dispenser may further include a hub supported by the base, a cannula extending upward from the hub, and a dispensing tip in fluid communication with the cannula depending downward from the hub and inserted into the blood entry port of the cartridge when the dispenser base is mated with the cartridge convex top portion.

### RELATED APPLICATIONS

This application is a continuation-in-part application of U.S. patent application Ser. No. 13/385,680 filed Mar. 1, 2012 and claims the benefit of and priority thereto under 35 U.S.C. §§119, 120, 363, 365, and 37 C.F.R. §1.55 and §1.78 and which is incorporated herein by this reference.

### FIELD OF THE INVENTION

The subject invention relates to blood and other fluid dispensers.

### BACKGROUND OF THE INVENTION

Various dispensers have been designed to transfer blood and other liquids from a stoppered test tube to a slide. Most dispensers have some kind of a base and a cannula extending outwardly therefrom. U.S. Pat. Nos. 5,697,522 and 5,344,666, both incorporated herein by this reference, disclose bases with a plurality of stabilizing legs. U.S. Pat. No. 5,163,583, also incorporated herein by this reference, discloses a different design with a skirt about the cannula which is supported by a solid disk. See also the Helena Laboratory Corp's. “H-Pette” products.

The state of the art in blood analyzers includes a cartridge with a blood entry port. A dispenser is used to transfer one or two drops of blood from a stoppered test tube to the cartridge via the blood entry port thereof. The cartridge is loaded into a hand held blood analyzer. See, for example the Abbott “i-STAT” blood analyzer system and U.S. Pat. Nos. 5,096,669; 7,419,821; 6,750,053; and 5,447,440 incorporated herein by this reference.

Conventional dispensers can be awkward to use with such systems. For example, the “C-pette” dispenser has a dispensing tip below a round disk with a flat bottom. When used in connection with the “i-STAT” cartridges, the dispensing tip doesn't go very far into the blood entry port of the cartridge and the round disk does not seat on the cartridge.

### SUMMARY OF THE INVENTION

In examples of the invention, a dispenser is provided with a dispensing tip configured to be received well into the cartridge blood dispensing port and the dispenser has a base portion configured to seat on the cartridge top portion. In this way, when the test tube is pushed downward to transfer blood from the test tube to the cartridge via the dispenser, the dispenser is stable on the cartridge.

A blood testing system features a blood analyzer and a cartridge loadable into the blood analyzer. In one example, the cartridge includes a convex top portion with a blood entry port therein. A dispenser for transferring blood in a stoppered test tube to the cartridge is designed to include a contoured, stabilizing base configured to mate with the cartridge convex top portion. A hub is supported by the base and a cannula extends upward from the hub. A dispensing tip is in fluid communication with the cannula and depends downward from the hub to be inserted into the blood entry port of the cartridge when the dispenser base is mated with the cartridge convex top portion.

In some examples, the dispenser base includes spaced front and rear concave arch members connected by spaced, straight side rails. One or both spaced side rails may include an inward undercut feature. The base may further include one or more spokes interconnecting the base with the hub. In one version, a spoke extends inwardly from each rail to the hub.

The cannula may include a lower plastic portion and an upper metal portion fit into the lower plastic portion. Preferably, the dispensing tip is tapered and has an outer diameter proximate the hub slightly smaller than the inner diameter of the blood entry port. The dispenser base, hub, and dispensing tip are preferably made of plastic.

Also featured is a dispenser for transferring fluid in a stoppered test tube to a cartridge with a convex top portion including a fluid entry port therein. The dispenser comprises a contoured, stabilizing base configured to mate with the cartridge convex top portion, a hub supported by the base, a cannula extending upward from the hub, and a dispensing tip in fluid communication with the cannula depending downward from the hub and insertable into the fluid entry port of the cartridge when the dispenser base is mated with the cartridge convex top portion.

One dispenser is configured for transferring fluid in a stoppered test tube to a cartridge with a top portion including a blood entry port. The dispenser may include a base formed to seat on the cartridge top portion. A hub is supported by the base and a cannula extending upward from the hub. A dispensing tip is in fluid communication with the cannula and depends downward from the hub and is insertable into the fluid entry port of the cartridge when the dispenser base is seated on the cartridge top portion.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic three dimensional front view of a blood analyzer and a cartridge loadable therein;

FIG. 2 is a schematic view showing one example of a cartridge for use with the blood analyzer of FIG. 1;

FIG. 3 is a schematic top view showing an example of a dispenser in accordance with the invention seated on the cartridge of FIG. 2;

FIG. 4 is a schematic three dimensional end view showing the dispenser seated on the cartridge and the dispenser cannula inserted into a test tube through a stopper thereof;

FIG. 5A is a schematic three dimensional front view showing the design of one particular dispenser in accordance with examples of the invention;

FIG. 5B is a schematic three dimensional bottom view of the dispenser of FIG. 5A;

FIG. 5C is a schematic cross-sectional front view of the dispenser of FIGS. 5A-5B; and

FIG. 6 is a schematic three dimensional front view of a prior art dispenser.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

FIG. 1 shows handheld blood analyzer 10 and cartridge 12 loadable into analyzer 10 for analysis of blood dispensed into cartridge 12. See the Abbott “i-STAT” system referred to in the Background section above. FIG. 2 shows one example of cartridge 12. Cartridge 12, in this particular example, includes convex top portion 14 with blood entry port 16 therein. A ledge 18 is formed on the left side of the concave portion. There is a slight rim 50 which extends around the right hand side of the cartridge.

In one example of the invention, dispenser 20 FIGS. 3-4 includes base 22 with a concave stabilizing rim contoured to mate with the convex top portion 14 of cartridge 12. Also, in this particular example, the bottom of rim rail 24a rests on cartridge ledge 18 when the dispensing tip is inserted into the blood entry port of the cartridge. Also, rail 24b may partially rest on the side rim of the cartridge and/or include features as discussed herein which mate with or engage the side rim about the cartridge.

The dispenser is thus stable on the cartridge when used to transfer blood (or other fluid) from stoppered test tube T show in phantom in FIG. 4 to the blood entry port of the cartridge and while the test tube is pushed downward to transfer blood. Typically, each downward push of the test tube forces a single drop out of the dispensing tip of the dispenser into the blood entry port of the cartridge.

In one design, the dispenser hub 26 is supported by spaced front 28a and rear 28b arch members interconnected by spaced side rails 24a and 24b which have straight lower edges. A spoke 30a, 30b extends inwardly from each rail 24a, 24b to hub 26 supporting it with respect to base 22. Cannula 32 extends upward from hub 26 and may include lower larger diameter plastic portion 34 and upper smaller diameter metal portion 34b fit into plastic portion 34a. Except for metal cannula portion 34b, all the other components of the dispenser are preferably molded out of medical grade plastic material. In FIG. 4, metal cannula portion 34b is shown inserted into the test tube and preferably the inner diameter of cannula portion 34b, of cannula portion 34a and of the dispensing tip of the dispenser are configured such that each downward push of the test tube dispenses one drop of blood into the cartridge blood entry port.

FIGS. 5A-5C show dispensing tip 40 in fluid communication with cannula 34a and depending downward from hub 26 and configured to be received in the blood entry port of the cartridge when the dispenser base 22 is mated to the convex cartridge top portion 14, FIG. 2. Dispensing tip 40 may be tapered as shown and has a larger outside diameter (for example, 0.140″) proximate hub 26 tapering to a smaller diameter at the distal end of the dispenser tip as shown. The cartridge blood entry port inner diameter is typically slightly greater than 0.140″ so the dispensing tip is fully or almost fully received in the blood entry port of the cartridge when the dispenser base is mated to the cartridge. This prevents the introduction of air bubbles into the fluid path.

Thus, in FIGS. 3-4, for example, the dispenser cannot slide forward or rearward since the dispenser tip is received in the blood entry port of the cartridge. The dispenser cannot rock to the left in the figure because rail 24a engages cartridge ledge 18. Because the dispenser tip is in the blood entry port of the dispenser and due to arched front and rear base members 28a and 28b mating with the curvature of the convex top portion of the cartridge, the dispenser is fairly stable and will rock only slight to the right in the figures. To that end, cartridge 12, FIG. 2 has a slight rim at 50 extending around the right side of the cartridge and bottom dispenser rails 24a, 24b, FIG. 5C have an inner under cut as shown at 52 so the bottom 54 of rail 24b, for example, and/or undercut 52 catches the edge rim of the cartridge for greater stability as the blood in a test tube is transferred to the cartridge blood entry port through cannula 34b, FIG. 5A inserted into the test tube stopper, through cannula 34a and out dispensing tip 40 inserted into the blood entry port of the cartridge.

In contrast, FIG. 6 shows a prior art dispenser 70 with dispensing tip 72 below round flat bottom disk 74 supporting cannula 76. Only the most distal portion of the dispensing tip 72 can be fit into the cartridge blood port and round disk 74 does not touch the cartridge. Thus, dispenser 70 rocks in all directions when an attempt is made to transfer blood from a test tube to the cartridge. Other prior art dispensers can also be awkward to use.

In the particular design of FIGS. 5A-5C, side rails 24a and 24b support the distal end of dispensing tip 0.05″ up from the bottom of the rails. Arched base members 28a, 28b have a radius of 5° mirroring the radius of the card convex top portion 14. Base 22 may be 0.455″ wide by 0.385″ deep (e.g., rails 24a, 24b are 0.385″ long).

These designs may vary in the overall structure and the base may vary as well to conform the base to particular feature(s) of a cartridge proximate the blood entry port thereof for other cartridge designs.

Thus, although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A blood testing system comprising:
a blood analyzer;
a cartridge loadable into the blood analyzer, the cartridge including a convex top portion with a blood entry port therein; and
a dispenser for transferring blood in a stoppered test tube to the cartridge,
the dispenser including:
a contoured, stabilizing base configured to mate with the cartridge convex top portion,
a hub supported by the base,
a cannula extending upward from the hub, and
a dispensing tip in fluid communication with the cannula depending downward from the hub and inserted into the blood entry port of the cartridge when the dispenser base is mated with the cartridge convex top portion.

2. The system of claim 1 in which the dispenser base includes spaced front and rear concave arch members connected by spaced side rails.

3. The system of claim 2 in which one or both spaced side rails include an inward undercut feature.

4. The system of claim 2 in which the rails are straight.

5. The system of claim 2 in which the base further includes one or more spokes interconnecting the base with the hub.

6. The system of claim 5 in which there is a spoke extending inwardly from each rail to the hub.

7. The system of claim 1 in which the cannula includes a lower plastic portion and an upper metal portion fit into the lower plastic portion.

8. The system of claim 1 in which the dispensing tip is tapered.

9. The system of claim 8 in which the dispensing tip has an outer diameter proximate the hub slightly smaller than the inner diameter of the blood entry port.

10. The system of claim 1 in which the dispenser base, hub, and dispensing tip are made of plastic.

11. A dispenser for transferring fluid in a stoppered test tube to a cartridge with a convex top portion including a fluid entry port therein, the dispenser comprising:
a contoured, stabilizing base configured to mate with the cartridge convex top portion;
a hub supported by the base;
a cannula extending upward from the hub; and
a dispensing tip in fluid communication with the cannula depending downward from the hub and insertable into the fluid entry port of the cartridge when the dispenser base is mated with the cartridge convex top portion.

12. The dispenser of claim 11 in which the dispenser base includes spaced front and rear arch members connected by spaced side rails.

13. The dispenser of claim 12 in which one or both spaced side rails include an inward undercut feature.

14. The dispenser of claim 12 in which the rails are straight.

15. The dispenser of claim 12 in which the base further includes one or more spokes interconnecting the base with the hub.

16. The dispenser of claim 15 in which there is a spoke extending inwardly from each rail to the hub.

17. The dispenser of claim 11 in which the cannula includes a lower plastic portion and an upper metal portion fit into the lower plastic portion.

18. The dispenser of claim 11 in which the dispensing tip is tapered.

19. The dispenser of claim 18 in which the dispensing tip has an outer diameter proximate the hub slightly smaller than the inner diameter of the fluid entry port.

20. The dispenser of claim 11 in which the dispenser base, hub, and dispensing tip are made of plastic.

21. A dispenser for transferring fluid in a stoppered test tube to a cartridge with a top portion including a blood entry port, the dispenser comprising:
a base formed to seat on the cartridge top portion;
a hub supported by the base;
a cannula extending upward from the hub; and
a dispensing tip in fluid communication with the cannula depending downward from the hub and insertable into the fluid entry port of the cartridge when the dispenser base is seated on the cartridge top portion.

22. The dispenser of claim 21 in which the dispenser base includes spaced front and rear arch members.

23. The dispenser of claim 22 in which the base includes spaced side rails connecting the front and rear arch members.

24. The dispenser of claim 23 in which one or both spaced side rails include an inward undercut feature.

25. The dispenser of claim 23 in which the rails are straight.

26. The dispenser of claim 23 in which the base further includes one or more spokes interconnecting the base with the hub.

27. The dispenser of claim 26 in which there is a spoke extending inwardly from each rail to the hub.

28. The dispenser of claim 21 in which the cannula includes a lower plastic portion and an upper metal portion fit into the lower plastic portion.

29. The dispenser of claim 21 in which the dispensing tip is tapered.

30. The dispenser of claim 29 in which the dispensing tip has an outer diameter proximate the hub slightly smaller than the inner diameter of the blood entry port.

31. The dispenser of claim 21 in which the dispenser base, hub, and dispensing tip are made of plastic.
